(19) United States
(12) Patent Application Publication
(10) Pub. No.: US 2009/0103707 A1
(43) Pub. Date: Apr. 23, 2009

(54) System and method for enhanced ENUM applications

(76) Inventors: Faith McGary, Bethlehem, PA (US); Michael Bates, Worthington, OH (US); Robert Pines, New York, NY (US)

Correspondence Address: SOFER & HAROUN LLP., 317 MADISON AVENUE, SUITE 910, NEW YORK, NY, 10017, US

(21) Appl. No.: 12/283,739

(22) Filed: Sep. 15, 2008

Related U.S. Application Data
(63) Continuation-in-part of application No. 11/494,262, filed on Jul. 27, 2006.
(60) Provisional application No. 60/703,510, filed on Jul. 28, 2005.

(51) Int. Cl. H04M 3/42

(52) U.S. Cl. 379/218.01

(57) ABSTRACT

An identification services system having a database module configured to support an account for a subscriber having at least one identification code relating to the subscriber. A services platform allow the subscriber of the account to map any one of a plurality of objects and locations to the account, each having a unique identifier such that information corresponding to the objects and location is provided for storage in the database module using the account. The identification code and the unique identifiers are communicated to the services platform and are associated to the subscriber account. A response platform communicates with the subscriber, providing updated advertising information to the subscriber based on the information received corresponding to the objects and locations.

### RELATED APPLICATION

This application is a CIP of U.S. patent application Ser. No. 11/494,262, filed on Jul. 27, 2006, which claims the benefit of priority from U.S. Provisional Patent Application No. 60/703,510, filed on Jul. 28, 2005, the entirety of which are incorporated herein by reference.

### FIELD OF THE INVENTION

The present invention relates to the field of directory assistance. More particularly, the present invention relates to directory assistance for use with ENUM and other applications employing unique identification codes to identify a subscriber.

### BACKGROUND OF THE INVENTION

The average business card today contains an ever increasing amount of contact information for a person to remember. A typical business card for example may contain a telephone number, a pager number, a fax number, a VoIP address and an e-mail address.

Combining the need to simplify the storage and addressing of contact information for individuals having multiple devices and address, with the new advances in IP packet-switched telephone networks, ENUM or Electronic Number has been developed. ENUM is a telephone mapping protocol developed by the Internet Engineering Task Force (IETF) that employs an existing telephone number or a newly assigned number (similar in size to a telephone number) to access various devices of a user. For example, it enables what would traditionally be circuit-switched traffic to be carried along a packet-switched network, because it may match a circuit address (a telephone number) to a network address (a URL). Because this traffic is not restricted to traveling along a dedicated line, flow of traffic becomes more efficient and much more flexible. The ENUM protocol allows users to receive calls originating from other VoIP telephones or from PSTN phones, as well as from other digital devices seamlessly.

However, with ENUM being a packet switched communication there is an unfulfilled potential for additional services. Furthermore, even if an ENUM exists for an individual or business, there is currently no way to know this ENUM without them directly providing it to a caller.

### OBJECTS AND SUMMARY

It is a first object of the present invention to provide a system for coupling additional data to a traditional ENUM account for a subscriber. Thus, additional applications may be coupled to a subscriber's ENUM in order to provide additional functionality to the number. These additional features may include attachment of additional account information by basic contact numbers, such as banking or e-commerce applications. Furthermore, the present invention, utilizing the fact that ENUM is based on IP addressing, may attach any devices, such as home computers, digital TV's DVD/burners etc. . . . such that the subscriber, using their ENUM account, is enabled to access any Internet device that is associated with their account using the single ENUM number. In accordance with another embodiment of the invention the system also allows non-internet enabled devices, and objects to be registered, or mapped or attached to a subscriber's account.

It is a second object of the present invention to provide enhanced directory assistance to a caller, allowing them to request and be connected to a subscriber's ENUM of a desired party.

It is a third object of the present invention to allow subscribers place orders for goods and services based on a single unique identification corde or number, such as their ENUM, MIN or ANI. To this end, service and good providers may have access to the subscriber's usage of goods and services and based on such usage may provide promotions or competitive pricing.

To this end, the present invention is directed to an Unique Code Identification services system includes a server module configured to support an account for a subscriber. The account has at least one incoming contact number for the subscriber and one or more preferred outbound contact addresses, such that when a caller calls the single incoming contact number the call is connected to the subscriber on one or more preferred outbound contact addresses. A supplemental services platform is coupled to the server module to allow the subscriber of the account to map additional internet ready devices and non-internet ready devices and objects and locations to the account, so that the subscriber may contact the system using the account to remotely control the additional internet ready devices, and/or place orders for goods and services associated with the additionally mapped objects and locations.

The present invention further provides for a response platform configured to communicate with the subscriber, the response platform providing updated advertising information to the subscriber based on information received corresponding to objects and locations mapped to the subscribers account.

The present invention further provides for a response platform configured to communicate with the subscriber, the response platform providing updated shopping lists corresponding to objects that are desired by the subscriber to be replenished.

The present invention further provides for a response platform configured to communicate with said subscriber, said response platform configured to receive information identifying a lost object via a mobile device and based on said information enabling said system to retrieve the identity of the owner of said object.

### BRIEF DESCRIPTION OF THE DRAWINGS

The subject matter regarded as the invention is particularly pointed out and distinctly claimed in the concluding portion of the specification. The invention, however, both as to organization and method of operation, together with features, objects, and advantages thereof may best be understood by reference to the following detailed description when read with the accompanying drawings in which:

FIG. 1 is a block diagram of an ENUM services system, in accordance with one embodiment of the present invention;

FIG. 2 is a basic ENUM account profile for the ENUM services system of FIG. 1, in accordance with one embodiment of the present invention;

FIG. 3 illustrates a typical call from a caller to an ENUM subscriber, from the ENUM services system from FIG. 1, in accordance with one embodiment of the present invention;

FIG. 4 is a domain tree illustration for an ENUM, in accordance with one embodiment of the present invention;

FIG. 5, is a block diagram of the ENUM services system from FIG. 1, with a supplemental services platform, in accordance with one embodiment of the present invention;

FIG. 6 is an enhanced subscriber account profile, in accordance with one embodiment of the present invention;

FIG. 7 is flow diagram of a subscriber accessing additional devices, objects and locations via the supplemental services platform from FIG. 5, in accordance with one embodiment of the present invention;

FIG. 8 is flow diagram of a subscriber accessing additional services, such as financial services via the supplemental services platform from FIG. 5, in accordance with another embodiment of the present invention;

FIG. 9 is flow diagram of a subscriber accessing additional services via the services platform from FIG. 5, in accordance with another embodiment of the present invention;

FIG. 10 is a block diagram of the ENUM Directory Assistance platform system, in accordance with one embodiment of the present invention; and

FIG. 11 is a flow chart illustrating a directory assistance call requesting the ENUM of a subscriber, in accordance with one embodiment of the present invention.

### DETAILED DESCRIPTION

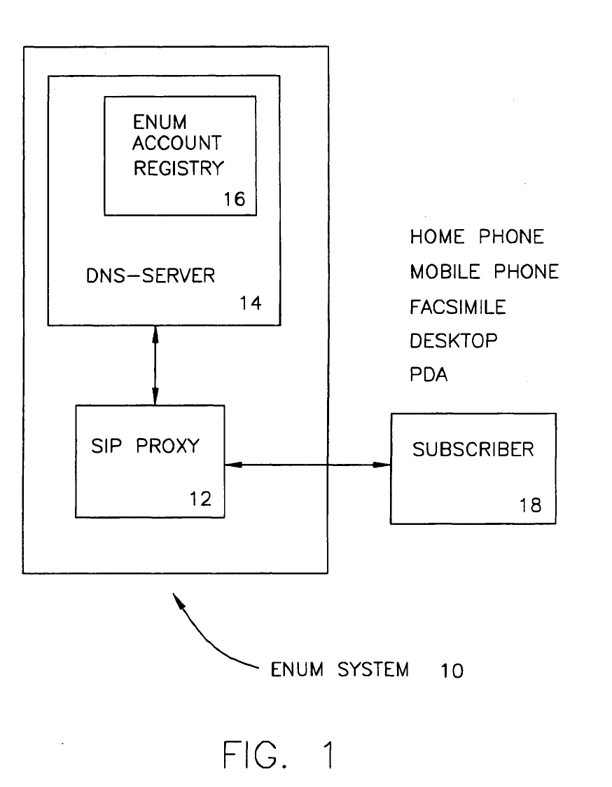

In one embodiment of the present invention, as illustrated in FIG. 1, ENUM services system 10 employs a traditional SIP (Session Initiation Protocol) proxy 12 and a DNS (Domain Name System) server 14. SIP proxy is configured to receive incoming communications to system 10, and DNS server 14 handles the incoming calls as outlined in more detail below. DNS server 14 further maintains an ENUM account registry 16 for storing ENUM account information for a plurality of subscribers 18, who maintain ENUM accounts with system 10.

Subscriber 18 first contacts system 10 and establishes an ENUM account. This is accomplished by having system 10 assign a contact telephone number to subscriber 18. Typically, the contact telephone number is simply a standard 10 digit telephone number, either a pre-existing number or newly created number, which when dialed by a caller 20 connects the outgoing call to subscriber 18 in a manner prescribed in the account. It is understood that system 10 is equally applicable to (800), International and private network ENUMs.

In setting up the account, after the contact telephone number is assigned, subscriber 18 registers one or more contacts addresses (devices) to the ENUM, such as mobile telephones, land line telephones, fax machines, voice mail accounts, IM (Instant Message) or e-mail accounts, VoIP phone addresses, PDA's. For example, subscriber 10 might wish to register a first mobile telephone number to the ENUM account, a second home telephone, a third VoIP telephone, an e-mail address and finally a fax machine all accessible to a caller 20 when they enter the single contact phone number of subscriber 18. The information for the registered contact addressed are saved in what are called NAPTR (Naming Authority Pointer) Resource Records in ENUM account registry 16. It is understood that any connectivity address or device, voice or text, may be registered to the ENUM account by subscriber 18. As will be explained in more detail, in accordance with other embodiments of the invention, other objects and locations are also registered to an account by subscriber 18.

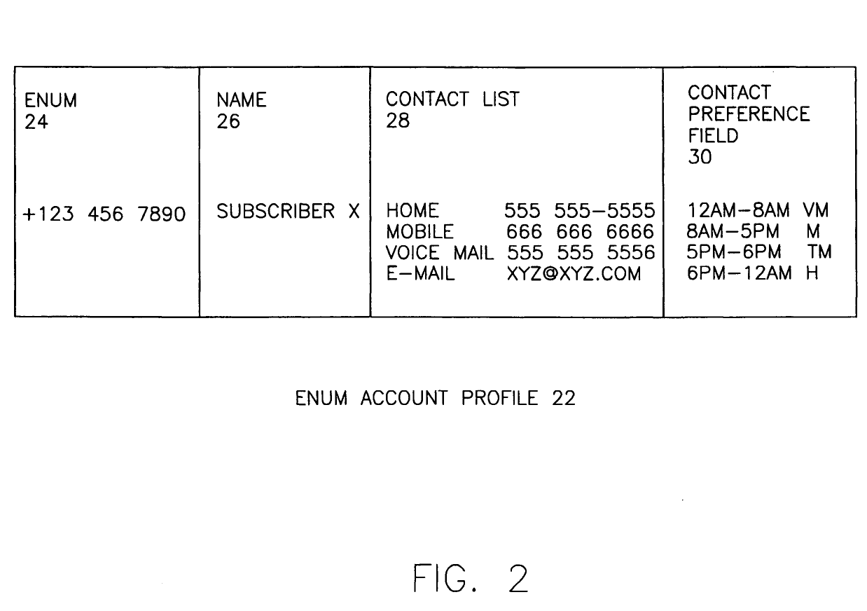

As illustrated in FIG. 2, a typical ENUM account profile 22 is shown. ENUM account profile 22 maintains a contact telephone number field 24 identifying the number contact for the account. A name field 26, stores the name of subscriber 18 attached to profile 22. A contact list field 28 lists the registered contact addresses or devices for the account. In the illustrated Example, subscriber 18 has registered three contact devices and an e-mail address:

| | |
|---|---|
| Home Phone | 555 555-5555 |
| Cell Phone | 666 666-6666 |
| Voice Mail system | 555 555-5556 |
| E-MAIL | xyz@xyz.com |

Additionally, in a contact address preferences field 30, subscriber 18 has identified four time slots for different incoming call destinations for calls placed to the contact telephone number stored in contact telephone number field 24. Calls from 12 AM-8 AM are directed to voice mail; calls from 8 AM-5 PM are directed to the mobile number; calls from 5 PM-6 PM are converted to text and sent to the mobile number and finally calls from 6 PM-12 AM are sent to the home phone. Thus, by giving out a single ENUM to potential callers 20, subscriber 18 may be reached in their preferred format as per their settings in ENUM account profile 22.

It is understood that as a second option, in addition to preferences field 30 setting up the exact method of connection to subscriber 18, it may in turn, if the relevant device support such a feature, return a list of options to caller 20. For example, subscriber 18 may for a certain time frame set their contact address preferences field 30 to allow caller 20 to select between connection by text message or mobile telephone call. This would allow some flexibility to caller 20, to set the connection mode to one that is appropriate for the content of the message but leaves ultimate control with subscriber 18.

For the purposes of illustration the present description contemplates a caller 20 making a voice communication to subscriber 18 who is receiving the call in a voice telephony format. However, it is understood caller 20 may be generating an e-mail or text sent to the contact telephone number and subscriber 18 may receive such in an electronic format on their end (e-mail, SMS, facsimile, etc. . . . ). Likewise, the invention further contemplates that caller 20 may be operating in voice or text and subscriber 18 may be receiving in the opposite format (eg caller sends in voice and subscriber receives in text and vise versa). In such instances, system 10 contemplates a speech-to-text/text-to-speech module 15 to support any number of connectivity options, including any conversions from speech to text and text to speech, video to text etc. . . .

Furthermore, any number of additional timing options for contact address preferences field 30 can be used, including dual communications for the same time slot. For example, during a pre-defined time of day a call to the contact number of the ENUM account of subscriber 18 may result in the call being forwarded to their mobile telephone as well as being simultaneously converted to text and sent to an e-mail account.

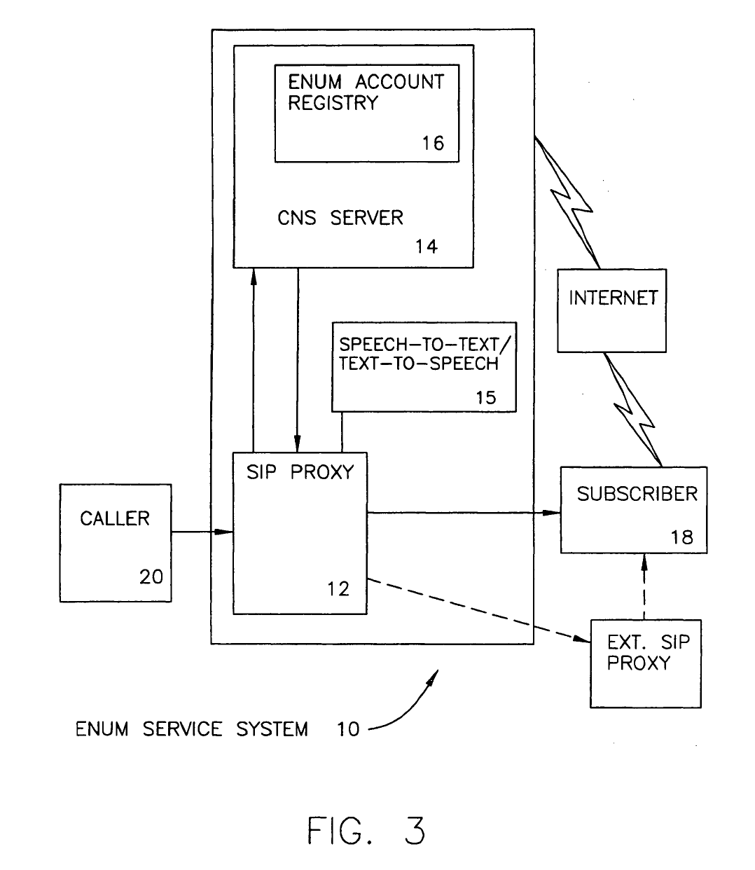

Once ENUM account profile 22 is set up, a caller 20 may place a call to subscriber 18 by dialing the contact telephone number. FIG. 3 illustrates a typical ENUM call flow to subscriber 18 from caller 20.

In order to place an ENUM call, caller 20 dials the contact telephone number associated with the ENUM account as it would normally be dialed. For example, the caller dials the number 1-202-555-1234, the contact number from profile 22 of subscriber 18. In cases where caller 20 dials less than a complete contact number (for example, a caller 20 within the 202 area code might leave off the “1,” or a caller 20 within an office system might dial only “1234”), it is contemplated the in network equipment in system 10 or other external network equipment of caller 20 recreates the complete form of the number for use with ENUM.

Next, the contact number is translated into an ENUM internet address that can be used by DNS server 14. Because this internet address is based on a complete international telephone number (in this example, +1-202-555-1234), a unique Internet address exists for every unique ENUM account. To determine if the contact number and corresponding Internet address are registered in ENUM account registry 14, the telephone number is translated in the following manner:

1. In this example, the contact telephone is 1-202-555-1234. This contact telephone number is first stored as +1-202-555-1234. “1” is the country code for the United States, Canada, and the seventeen other countries that make up the North American Numbering Plan (NANP). The “+” indicates that the number is a complete, international telephone number, known as an E.164 number. E.164 is the name of the international telephone numbering plan administered by the International Telecommunication Union (ITU). 2. All characters are removed except for the digits. Example: 12025551234

3. The order of the digits is reversed. Example: 43215552021

4. Dots are placed between each digit. Example: 4.3.2.1.5.5.5.2.0.2.1

5. The domain “e164.arpa” is appended to the end. Example: 4.3.2.1.5.5.5.2.0.2.1.e164.arpa

E164.arpa has been proposed as the DNS domain for use with ENUM. This designation may change as a result of ongoing discussions between the ITU, the Internet Engineering Task Force (IETF), and other international organizations involved with ENUM. In the event that the international community chooses a different ENUM domain, it is contemplated that the system and method discussed herein is equally applicable to the changed domain.

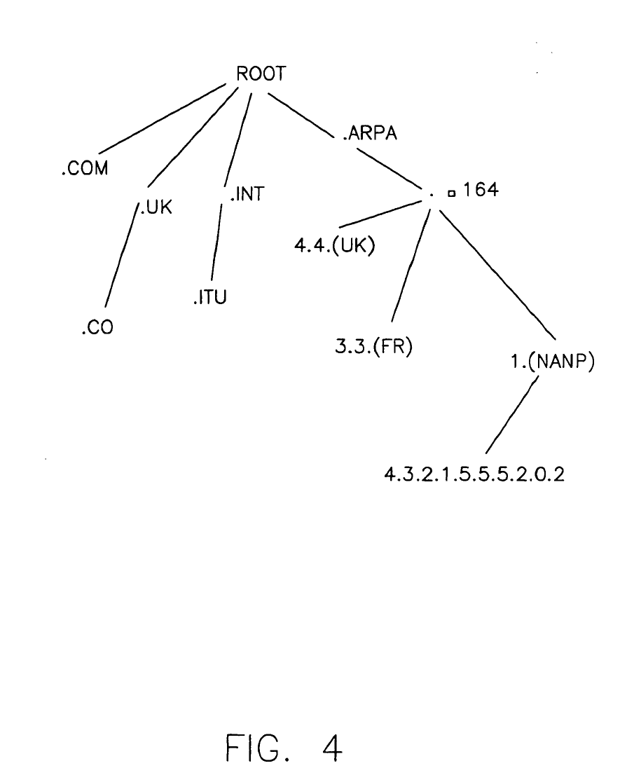

The “.arpa” domain is under the administrative management of the Internet Architecture Board (IAB). It has been designated specifically for Internet infrastructure purposes. ENUM is considered appropriate as an infrastructure application because it provides a set of DNS-based resource directories, referenced by phone number, for use by various ENUM-enabled application subscribers 18. The contact telephone number is reversed because DNS, such as at DNS server 14 reads addresses from right to left, from the highest level to the lowest level. In this case, a DNS lookup would start at the .arpa domain, and it would continue with .e164. Under e164 it would look for the “1” as the country code for the North American Numbering Plan. It would then look up each succeeding digit in the telephone number until the address is fully resolved. As illustrated in FIG. 4, if DNS begins to search under .arpa, it can then search under .e164, followed by the country code and reversed telephone number. DNS cannot, however, look under .int once it has begun to look in the .arpa tree. This diagram shows a number of branches, with top-level domains of .com, .uk, .int, and .arpa.

Once the ENUM of subscriber 18 is translated into an Internet address, a DNS query is issued on the domain, as previously described. One of two things can happen.

In the first instance, if an authoritative name server is found, such as DNS server 14 of system 10, the dialed contact telephone number retrieves the relevant NAPTR Resource Records and the call proceed according to profile 22 of subscriber 18, continuing to the desired registered communication address according to address preferences field 30.

It is understood that for such instances, subscribers 18 their name server is DNS server 14. In order to determine if the dialed number is a contact number of an ENUM account in account profile registry 16, the SIP proxy of caller 20 pings registry 16. In the case of callers 20 who use system 10 as their provider this simply entails SIP proxy 12 contacting account registry 16. However, if caller 20 is from another provider that supports ENUM connections, then their SIP proxy may, using the ENUM created from the contact telephone number, directly contact account registry 16 of DNS-sever 14 to obtain profile 22.

Depending on the preferences subscriber 18 contained in profile 22 the telephone call may be conducted entirely over the Internet as a VoIP call, without using the Public Switched Telephone Network or vise versa.

In the second instance, if an authoritative name server cannot be found, DNS server 14 returns a 404 Not Found error to the VoIP enabled telephone of caller 20, and, if possible, a connection to the PSTN is opened, and the call is routed conventionally, as it is assumed the dialed number is not an ENUM.

Returning to FIG. 3, subscriber 18 has registered for ENUM services with system 10 using the Session Initiation Protocol (SIP) address sip:name@domain.com of SIP server 12. A query based on the ENUM dialed by caller 20 is sent to DNS-server 14, which returns the correct SIP address and SIP proxy 12 sets up the call accordingly.

It is understood that the above described process is only one of a number of ways that ENUM can be used to set up a call between caller 20 and subscriber 18. The flow of information remains the same regardless of whether additional applications such as speech to text (call to e-mail, call to fax, call to text message). Furthermore, it is contemplated that if caller 20 is outside of network, or if subscriber 18 uses a different VoIP provider, SIP proxy 12 of system 10 may need to contact an additional one or more SIP proxy's on other networks to ensure call connection.

As identified above, ENUM supported by system 10 is invisible to both subscriber 18 and caller 20 from a telephony standpoint. The VoIP network of system 10 is accessible, either by use of an Internet-enabled telephone, or from a standard telephone that has access to either a soft switch (a switch that allows access to the IP network) or a circuit switch that has had IP-enabling software added to it. It is important to note that a call placed from an Internet-enabled telephone is also able to reach the Public Switched Telephone Network if the number dialed cannot be found on the Internet (is not a registered ENUM).

As outlined above, the voice application of ENUM in system 10 provides advantageous connectivity for subscriber 18. Along the same line as telephone usage however, faxing becomes flexible, and as efficient. In fact, for fax applications it is even more logical and much more efficient to use the IP network of system 10.

An Internet-enabled fax machine of subscriber 18 (or a fax machine on an Internet-enabled circuit-switched network) has the same basic functionality as an Internet-enabled telephone. As long as subscriber 18 has set up their contact list field 28 and contact preferences field 30 of ENUM profile 22 to register for fax services, another Internet-enabled fax machine is able to reach it using the ENUM. Otherwise, that fax machine remains reachable via traditional PSTN.

Furthermore utilizing the above described system 10, the use of e-mail becomes more feasible in accordance with the invention. Rather than typing in an email address, caller 20 may type the contact telephone number of subscriber 18 which is mapped to the ENUM account of subscriber 18. If that ENUM account has been mapped to an e-mail address in profile 22, the mail is sent, and the address lookup is invisible to both sender 20 and subscriber 18. In this case, sender 20 would first type in the complete, contact telephone number of subscriber 18.

ENUM system 10 may further be configured to enable traditional call-forwarding, follow-me, and do-not disturb functions, as well as new features that merge Internet applications with video and voice communications. Using applications that use SIP resources, a subscriber 18 using a telephone connection with their computer could be prompted on that computer that another call is arriving. Subscriber 18 could make a selection on the computer to either end the dialup session, answer the phone, forward the call to another number, or send caller 20 to voice mail. As another example, subscriber 18 could transfer caller 20 to a web page instead of to another phone. In this case, the call would end, and the web browser of subscriber 18 would open the new page. ENUM numbers are mapped with identifiers such as: First Name, Last, Name, Address, Credit Card Data, Personal Information.

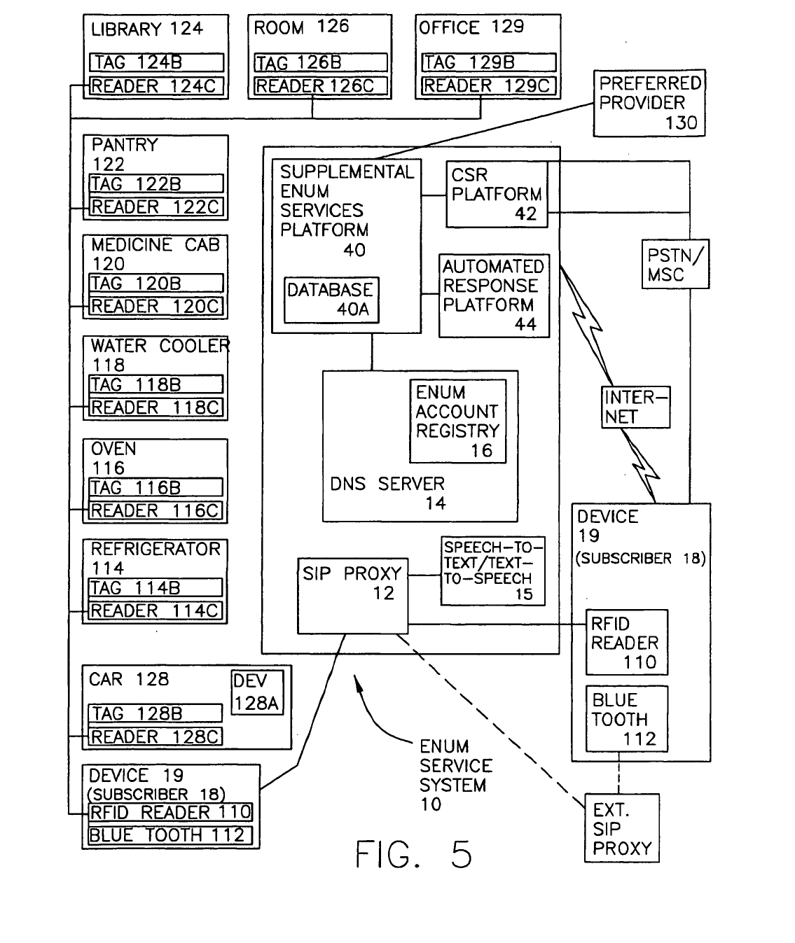

In another embodiment of the present invention, illustrated in FIG. 5, ENUM services system 10 further includes a supplemental ENUM services platform 40 coupled to DNS server 14 configured to allow subscriber 18 to register additional internet enabled devices to profile 22 beyond simple communication addresses.

Thus, in one embodiment of the present invention, as set forth in the list below, supplemental ENUM services platform 40 of system 10 provides mapping and control services to a number of additional items owned or controlled by subscriber 18 via their ENUM. Also, supplemental ENUM services platform 40 allows subscriber 18 to access their ENUM account, and add additional information such as financial (banking) information as well as to connect and map certain IP address capable devices to the account. Thus, using only their ENUM, subscriber 18 may control mapped devices also via contact through their ENUM and handle e-commerce transactions.

It is noted that in accordance with another embodiment of the invention, the system maps devices that may not be connected to the Internet. For example, non-internet enabled devices may also be mapped to the ENUM account. Furthermore, locations or objects within control, possession, or access of a user may also be mapped to the ENUM account as will be explained in more detail hereinafter.

It is further noted that although various exemplary embodiments of the present invention employ the use of ENUM for mapping objects and locations to a user's profile, the invention is not limited in scope in that respect. For example any other unique identification information that identifies a user's mobile device, such as a user's ANI or MIN is also employed to register additional objects, and locations to the user's profile. As such, for purposes of the present embodiments, the terms ENUM, MIN, ANI or other UIC (Unique Identification Code) is used interchangeably.

FIG. 5 illustrates one embodiment of the invention that allows the mapping of devices, objects and locations that are not internet enabled. To this end, subscriber 18 employs a mobile phone or a PDA device or any other mobile communication device 19. Device 19 includes an RFID tag reader 110. It is estimated that within the next few years a substantial portion of cellular phone devices will be capable of reading data from a variety of RFID labels. Alternatively, and in accordance with another embodiment of the invention, device 19 also includes a transceiver 112, such as a Bluetooth transceiver.

FIG. 5 in accordance with one embodiment of the invention, illustrates various devices, objects or locations that are capable of communicating with device 19. Such devices include various appliances, such as refrigerator 114, oven 116, water-cooler 118 and vehicle 128. Furthermore, locations such as a medicine cabinet 120, pantry 122, library 124, various rooms 126, or various individual offices in an organizations 128, in accordance with various embodiments of the invention are capable of communicating with device 19.

Each object or location illustrated in FIG. 5, in accordance with one embodiment of the invention includes a corresponding RFID tag or other identifier information. For example refrigerator 114 includes an RFID tag 114(b), and oven 116 includes an RFID tag 116(b), and so forth. To this end subscriber 18 may also attach additional RFID tags near their medicine cabinet, pantry, library or any other object and location within their possession, control or access.

In accordance with another embodiment of the invention, each of the exemplary objects and locations discussed above include their own individual tag reader as well that can continuously poll the contents within their immediate zone and actively transmit the information to device 19. For example, refrigerator 114, in accordance with one embodiment of the invention includes a tag reader 114c that is capable of polling all the items contained within the refrigerator based on the information provided from each item's individual RFID tags. In accordance with another embodiment of the invention, tag reader 114c is configured to actively transmit its information, allowing subscriber 18 to scan the contents of each of its designated zones remotely.

As the cost for individual RFID tags is becoming increasingly affordable and commercially feasible, falling to a few cents, the contents of any object or location can also be tagged by individual RFID tags. Many larger department stores and outlets have already begun attaching RFID tags to all their merchandise. Such RFID tags may contain the product Bar Code number or other standard identification information. As such, and in accordance with one embodiment of the invention, the contents of a refrigerator, may individually be identified by reading the information attached to their corresponding RFID tag. As such, a milk carton may include an RFID tag with bar code information that identifies the manufacturer, the type of product, the expiration date.

In accordance with another embodiment of the invention, for items that do not contain an RFID tag, user 18 may attach commercially available RFID tags. Typically, all RFID tags have at least one unique identification code that can be mapped to any desired description. As such, an RFID tag reader senses all the tags within is reception zone, along with the corresponding identification code. To this end, device 19 displays the unique number of an RFID tag attached to an item, and allows the user to interactively enter an identification explanation for the tag. For example, if user 18 desires to store an item in the freezer, an RFID tag can be attached to the freezer bag or container. Tag readers 112 and 114c retrieve the unique identification code of the attached tag and interactively display the code on device 19. User 18 can then enter the identification of the contents in the bag and the date that it has been stored in the freezer and any expiration dates after which the user desires to dispose of the bag, if not used earlier. This information is later stored in the user's profile. System 10 includes a database, such as 40a that stores such information associated with all individual and organizations subscribed to the system, such as subscriber 18.

In accordance with one embodiment of the invention, device 19, such as a cell phone includes an RFID tag reader 118 as mentioned before. When a subscriber is within the vicinity of any of the objects or locations mentioned above, device 19, either automatically or manually reads the information contained in each of the tags attached to various objects and locations.

During operation, subscriber 18 receives the identification codes from each of the RFID tags. If the tags already include product identification information, such as bar code type information, device 19 sends that information to system 10 to search and retrieve its corresponding information. For example, in the case of the milk carton example mentioned above, RFID tag reader 118 of cell phone 19 receives the bar code information, transmits the information to system 10. System 10 searches its databases and transmits back the detailed information to device 19 as will be explained in more detail afterwards. For tags that do not include product information, as mentioned before, user 18 provides the identification information that is also stored in system's 10 database.

For articles or objects that do not have RFID tags or that may require the transfer of information that contains more data that can be handled by RFID technology, in accordance with one embodiment of the invention, other communication technology is employed such as Bluetooth. For example, subscriber 18 may desire to map his car 128 to the system. Car 128 includes sensors 128a that provide information regarding various modules in the car via for example Bluetooth technology. Sensors 128a may provide information about the car's fuel level, oil, temperature, braking system, and various engine information. Such information can be transmitted to device 19's Bluetooth transceiver 112. This information can further be transmitted to system 10 for further analysis, and the results can be sent back to device 19.

In one embodiment of the present invention, below is a list of further exemplary features and devices that may be mapped or enabled through the ENUM account for subscriber 18:
1. Cable TV
2. Satellite TV
3. Operator Services (non-directory assistance, such as reservations or directions)
4. Directory Assistance (traditional contact look-up)
5. Retail Operations (on-line or telephonic commerce)
6. Banking Features (telephonic or online account access and bill payments)
7. MVNO (Mobile Virtual Network Operator) (connection to non-network equipment owning virtual operators for additional services such as music downloads)
8. Internet/Digital formats
9. Communication Transport (cross-protocol communications)
10. Presence based communications
11. Enhanced CRM (Customer Relationship Management) integration with telephony systems
12. Episode information to screen pops
13. Interactive Voice Response Systems
14. Self Service Adoption (unattended payment)
15. Customer Enabling Environments
16. Biometric Authentication (storage of biometric security data for accessing own ENUM account or other secure features)
17. Real time ordering system for NVOD (Near Video On Demand)
18. Micro Transaction Processing (small on-line payments
19. PABX to CRMs (Private Automatic Branch Exchange) (Customer Relations Management)

Thus in one embodiment, system 10 of the present invention allows subscriber 18 to map additional IP enabled devices to their ENUM account so that they may gain additional remote operating capabilities, using only their ENUM. For example, subscriber 18 may map an IP enabled DVD player to their account or possibly their digital cable account as discussed in more detail below.

Furthermore, in addition to mapping devices to their ENUM account, subscriber 18 may also attach financial data such as financial account information, or other similar personal information. This information may typically include information such as bank account numbers and passwords.

In either case, whether adding personal/account information or device IP addresses to the ENUM account, such a process is typically handled on-line where subscriber 18 accesses system 10 by web. Alternatively, subscriber 18 may generate and modify the account verbally, either with the assistance of a live customer service representative 42 or with an automated IVR module 44 within system 10 coupled to supplemental ENUM services platform 40.

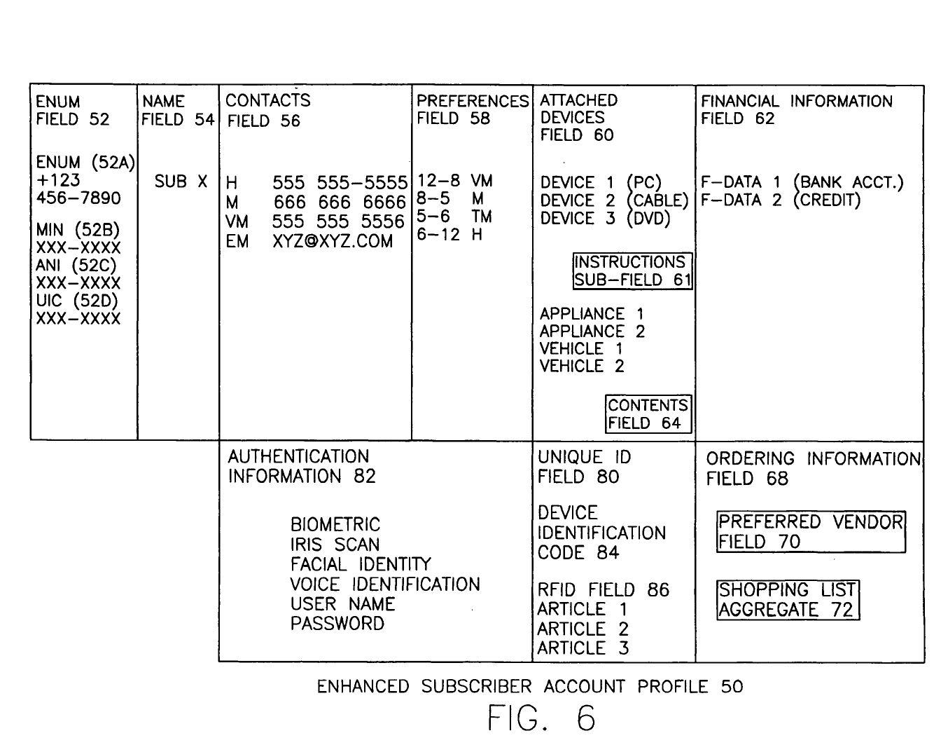

In one embodiment of the present invention as illustrated in FIG. 6, an enhanced subscriber account profile 50 is shown having similar fields to standard profile 22. For example, enhanced subscriber account profile 50 maintains a Unique ID field 52 that includes an ENUM field 52a identifying the contact telephone number for the account, an MNI field 52b identifying another contact telephone number for the account or an ANI field 52c identifying yet another contact telephone number for the account and a Unique Identification field UIC field 52c identifying yet another identifying number that the user can use to identify his or her account.

Account profile 50 also includes a name field 54, that stores the name of subscriber 18 attached to profile 50. A contact list field 56 lists the registered contact addresses for the account. Similar to profile 22, in the illustrated example in FIG. 6, subscriber 18 has registered four contact devices/addresses:

| | |
|---|---|
| Home Phone | 555 555-5555 |
| Cell Phone | 666 666-6666 |
| Voice Mail system | 555 555-5556 |
| e-mail | xyz@xzy.com |

Additionally, in a contact address preferences field 58, subscriber 18 has identified four time slots for different incoming call destinations for calls placed to the ENUM in contact preferences field 56.

However, enhanced subscriber account profile 50 also maintains attached devices field 60 with supplemental device instructions sub-field 61. Field 60 includes the devices that subscriber 18 has added to his/her stored profile, such as the personal computers, cable tv, DVD player, appliances, medicine cabinet, pantry, file folders, vehicles, books, rooms, offices and any other object or location that user desires to associate with his or her account. Contents subfield 64 within field 60 stores the contents for each of the objects and locations the user has associated with the account.

In accordance with various embodiments of the invention, field 60 also includes the unique identifier code for each mapped or registered device, object or location associated with a subscriber. For example, with various electronic devices, the device identification code, uniquely identifies the device, its manufacturer and additional details regarding the device.

In accordance with another embodiment of the invention, profile 50 also includes a Unique ID field 80 that stores an RFID field 86 containing the unique code for each mapped RFID tag and the corresponding description associated with that code and a device identification code field 84 that contains the unique code for each mapped device and the corresponding description associated with the code.

As will be explained in more detail, since all the fields of profile 50 are searchable, CSR platform 42 can uniquely identify subscriber 18, if for example only the RFID tag code or the device identification code is known. This feature of the system enhances the security of objects for identifying lost, misplaced or stolen goods based on the unique identification code on a tag.

Furthermore, content subfield 64 for each object, or location provides a list of items that are typically stored in that object or location. For instance subfield 64 for a refrigerator associated with the profile of subscriber 18, keeps track of all the objects in the mapped refrigerator. Additionally, subfield 64 also contains objects that are specified by subscriber 18 to be associated with the account. Again, with respect to a refrigerator, subscriber 18 may provide a list of items that are desired to be in the fridge or the freezer at all times. This allows the system to provide alerts or take other steps if an item in subfield 64 associated with an object or location is missing, next time that a tag reader polls all the RFID tagged items within the object or location.

Attached devices field 60 is configured to store a list of attached internet capable devices of subscriber 18 that are associated with their ENUM account for remote access/control. Supplemental device instructions sub-field 61 includes any pre-configured instructions and associated data (such as passwords etc. . . . ) that are associated with device included in field 60.

Profile 50 also includes a Financial data field 62. Financial data field 62 is configured to store the financial data (credit card, bank account information, etc. . . . ) of subscriber 18.

Enhanced subscriber account profile 50 in accordance with one embodiment of the invention also includes an Ordering information field 68. Field 68 includes a preferred vendor subfield 70 that includes subscriber's preferred vendor for each item mapped within profile 50. During operation, subscriber 18 has a choice of having a fixed set of preferred providers.

However, subscriber 18 may also be offered alternative preferred providers based on merchants and service providers who compete to become a preferred provider for the particular goods or objects identified with profile 50. Subscriber 18 may be enticed to accept this option for a reduced fee for using the system or even for a business model where the entire revenue of the system is based on advertising sponsors rather than subscription fees from the users.

Field 68 may also include a shopping list aggregator 72. A subscriber that maps an object or product to his or her account can also specify whether that item is preferably included in a subscriber's updated shopping list. Shopping list aggregator field 72 is continuously updated based on items that are missing based on a tag reading poll. Subscriber 18 specifies all items that need to be reordered. System 10 routinely retrieves the shopping list aggregator 72 data and employs various least cost analysis algorithms to find the best deals for all subscribers that are desirous of specific goods or objects.

In accordance with another embodiment of the invention, subscriber 18 also compiles shopping lists based on objects and items associated with the account and requests system 10 to retrieve comparative pricings from various participating vendors. Furthermore various vendors may also send promotional and advertising messages to subscriber 18 based on the information contained in fields 60 and 68.

Enhanced subscriber account profile 50 also includes an authentication information field 82 in accordance with one embodiment of the present invention. The authentication information field enables security for confirming orders and interacting with system 10. Filed 82 contains one or more authentication information, such as username and password and/or biometric information of subscribers who are authorized to interact with the system to access a specific account or accounts. This biometric information includes iris scan information, facial identity information, voice identity information, finger print information and other information that is capable of identifying the user and authorizing access to a specific account.

Turning now to an exemplary process for attaching or registering devices, objects and locations with a subscriber's account, subscriber 18 may access supplemental ENUM services platform 40 of system 10 in order to implement a centralized platform to associate all mapped or registered devices objects and locations with at least one unique identification code, such as the subscriber's ENUM, MIN, or ANI.

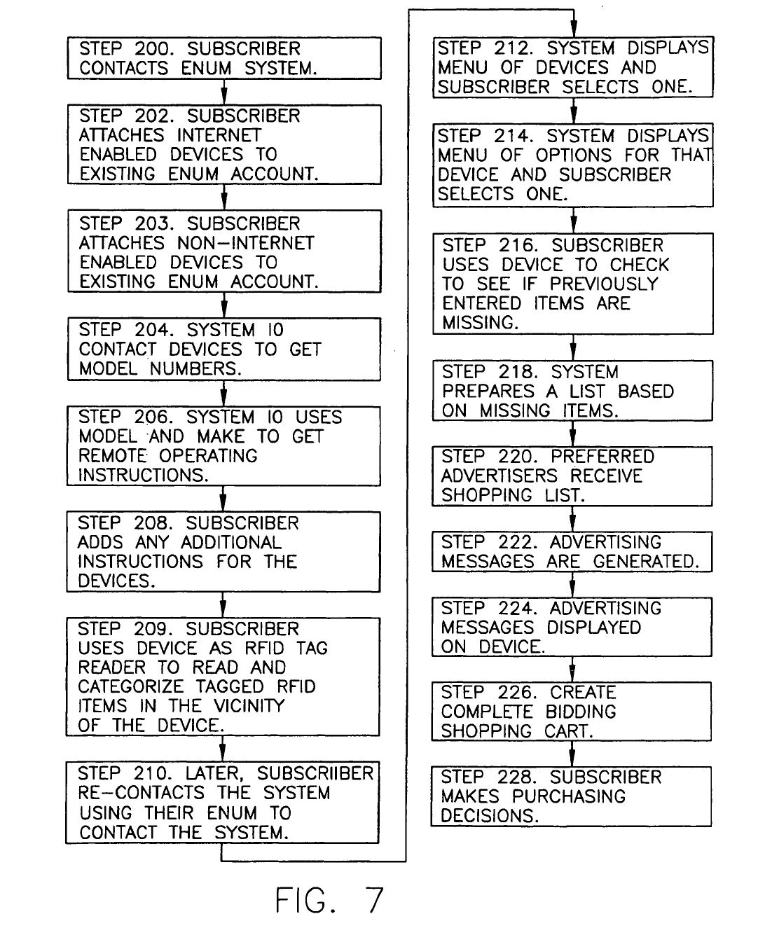

For example, as illustrated in the flow chart of FIG. 7, a subscriber 18 at step 100, may contact either the live customer service representative 42 or an automated module 44 and retrieve their account and associated enhanced subscriber account profile 50.

Next, at step 102, subscriber 18 may add/map any number of IP enable devices as described above to attached devices field 60. For example, in the case of DVD device #3 from profile 50 subscriber may wish to map their DVD player to their account. This entails subscriber 18 locating a device identifying number on the DVD player. For example, internet enabled devices include a MAC address (Media Access Control) which uniquely identifies the device. Alternatively the IP address being used to connect the DVD device #3 to the internet may also be used. Although this does not identify the device itself, it at least defines the address where the device is located.

Then at step 103 subscriber 18 maps/adds non-Internet enabled devices to the account. As mentioned before, these devices include any sort of objects, devices and locations having a unique identification code, such as those provided by an RFID tag.

At step 104, after user maps all of the desired devices, objects and locations to profile 50, system 10 determines whether it is capable to communicate with the mapped devices, locations or objects registered with the accounts. This communication may be accomplished either via an Internet connection to the registered device, or via the subscriber's PDA or cell phone device by remotely enabling the subscriber's tag reader poll the RFID tags within the vicinity of the device. This allows system 10 to remotely communicate with the mapped devices, locations and objects without the subscriber's intervention.

In the present Example, subscriber 18, for example, has mapped a DVD player to the account. So for this device, system 10 may ping the MAC address of IP address of this DVD player. If the MAC is used system 10 could then identify the make and model immediately, and if the IP address is used, system 10 may need to establish the make and model of the DVD player through a brief identification communication. Subscriber 18 has also mapped his home refrigerator that happens to include an active RFID reader/transmitter. System 10 sends a signal periodically to subscriber 18's PDA or mobile phone to enable the mobile device's RFID tag reader. When the subscriber is within the transmission zone of the refrigerator's RFID reader/transmitter, the mobile device's RFID tag reader receive the information about the refrigerator and the contents that have their individual RFID tags. To this end, system 10 can automatically update the status of all mapped devices, objects and locations.

Next, at step 106, system 10, knowing, for example, the make and model of the DVD player, contacts the manufacturer or other information source and obtains the contact and control instructions. It is understood that system 10 may simply store the directions for all devices it supports remote control for or it may contact the manufacturer for each device, depending on which arrangement works better for the devices being mapped. Alternatively, for devices which no instructions can be found, subscriber 18 may provide them to system 10 themselves. Regardless of how they are obtained, the remote operating instructions are stored in instructions sub-field 61.

At step 108, subscriber 18 for the case of the DVD player for example, may add any additional settings or pre-identified instructions to instructions sub-field 61. Such additional instructions may include but are not limited to modified instructions overtop of the pre-set manufacture instructions and scheduled automatic remote operations such as “Record channel X at 10:00 PM every Monday.”

Furthermore, at step 109, subscriber 18 using a mobile device equipped with a tag reader employs the device to retrieve the information coded in each tag so as to identify and categorize all tagged RFID items in the vicinity or reception zone of the mobile device. In the case of RFID tagged objects and locations, subscriber 18 may interactively add information regarding each item's expiration date, if perishable.

As such for items that have already been tagged by the manufacturer, system 10 receives the corresponding coded information and contacts all the necessary databases to update the information corresponding to the received code. For instance, for a milk container in refrigerator 114, system 10 is capable of obtaining the expiration date and any other information desired to be tracked by subscriber 18. Similarly for a medicine purchased and stored in medicine cabinet 120, system 10 is capable of obtaining expiration date, dosage information, pharmacy from which it was purchased, if a prescription medicine, the prescribing doctor's information.

System 10 is also capable of retrieving the medicine's image, such as an image of a pill contained in the container and send image and dosage alerts to subscriber 18's device. System 10 is also configured to send alerts for expired items that are still located in a designated location such as refrigerator 114 or medicine cabinet 120, alerting subscriber 18 to dispose of the expired item. To this end, manufacturer's and providers can contact system 10 to provide messages for all subscribers 18 that the system indicates have possession of their product or employ their service for various advertising, promotional or product alerts.

In accordance with another embodiment of the invention, system 10 may also assist subscribers 18 with locating lost or stolen objects. For example, when subscriber 18 maps a valuable object such as a painting or other artifact by attaching an RFID tag to the object, system 10 has a record of that object, description and history in profile 50 based on the information provided by the subscriber at the time of mapping the object to the account.

When subscriber 18 notifies the system that the object is missing or perhaps stolen, system 10 sets a flag for the RFID code corresponding to the lost object. In the case of the stolen object, when the item is presented to a bone fide buyer, system 10 can act as a clearing house to determine whether the object has been previously registered with a subscriber different from the one that is offering the object for sale. Furthermore, if the object is reclaimed by police authorities, they can contact system 10 to determine the rightful owner of the object.

Later, at step 110, subscriber reconnects to their account with system 10 by dialing the contact number for their account, similar to how voice mail is accessed on standard cellular telephones, although the invention is not limited in scope in that respect. For example, system 10 can be contact via any communication means, such as Internet, SMS and other means available to subscriber 18.

At step 112, system 10 recognizes subscriber 10, and presents a menu of devices, objects and locations, based on all of the registered, or mapped items. In the present Example, subscriber 18 could choose from their PC, their DVD player or their Cable television box or their appliances, vehicles, other objects and locations.

Assuming that subscriber 18 selects to proceed on the DVD player, then at step 114, system 10 presents a second menu to subscriber 18 with all of the available remote control options. For example, after system 10 obtains the remote operating instructions as noted above in step 106, system 10 has a list of supported operations. This list is displayed as a menu to subscriber 18 including such options as record channel, set up a scheduled recordation, turn off machine, copy disk to another location etc. . . . Such menu and subscriber selections can be handled through either automated platform 44 or live operator 42. An exemplary instructions may request that DVD recorder begin recording channel “#2 at 10:00 PM.”

The Examples of different IP enabled devices that can be controlled through the ENUM account with system 10 using supplemental services platform 40 are too numerous to recount in detail. It is understood that any similar account which allows mapping and control of IP enable devices owned by the subscriber, are also within the contemplation of the preset invention.

At step 116, device 19 of subscriber 18 periodically reads the information from each tagged item, device or location for updating the status of previously registered tagged items. For example, system 10 searches for all items, or objects that were previously mapped to the account and are now missing or expired, such as for example a milk carton in refrigerator 114.

At step 118, system 10 prepares a shopping list base on the information compiled and stored in field 68 for each of the accounts of all the subscribers. At step 120 system 10 provides the list of desired items to be purchased to preferred providers as previously specified by subscriber 18. As mentioned earlier the information relating to these preferred providers is stored in field 72 illustrated in FIG. 6. Such preferred providers then compile a shopping cart and send the information back to subscriber 18. If subscriber 18 is not interested in advertising messages, at step 128 each subscriber can review the shopping cart and make a purchasing decision by adding and removing items compiled in their list.

However, if subscriber 18 has agreed to receiving advertising and promotional messages, at step 122 system 10 provides the compiled shopping lists to its participating vendors and suppliers. Each vendor who is interested in providing advertising messages based on the items contained in the list can optionally send promotional messages to the subscriber, although the invention is not limited in scope in that respect. For example, participating vendors and suppliers can also receive a list of all items mapped to the subscriber's account, so as to provide customized advertising and promotional messages.

As such at step 122 system 10 receives generated advertising messages, promotions and coupons from its participating vendors and suppliers. The method of choosing which set of vendors and suppliers will be referred to the users can be based on any number of available bidding paradigms, such as highest bidder, a weighted bidding approach, etc. At step 124 system 10 provides the advertising messages for display on subscriber's device 19. Furthermore, in accordance with another embodiment of the invention, participating vendors and suppliers may receive the subscriber's shopping cart as generated by system 10 and provided a competitive pricing to the subscriber. This allows subscriber 18 to dynamically receive the best pricing for a bundle of items and objects that are in their shopping cart. Thereafter at step 128, subscriber 18 after comparing competitive pricing on the desired items that need to be purchased makes a purchasing decision, and provides that decision to system 10.

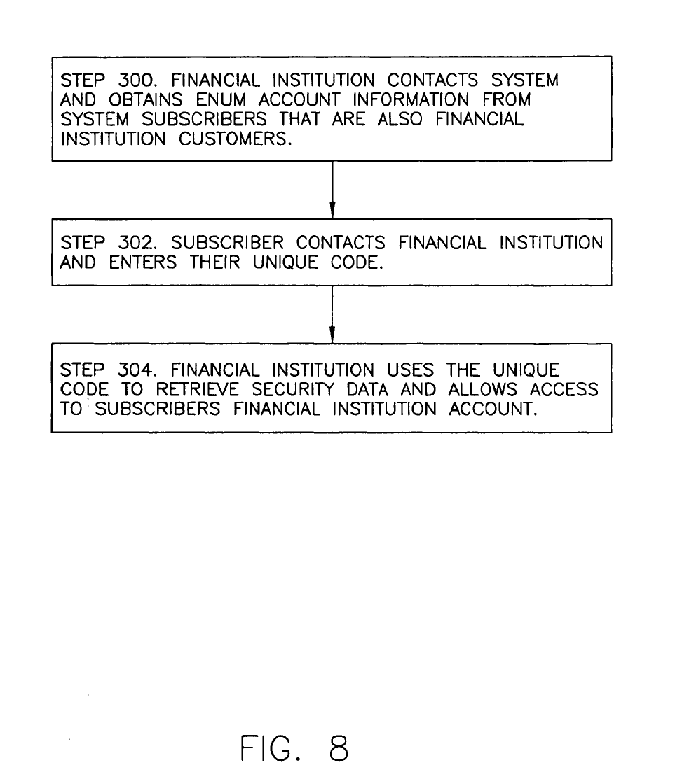

In another embodiment of the present invention, third parties may utilize the financial information of subscriber 18 stored in financial data field 62. For example, as illustrated in flow chart FIG. 8, at a first step 200, a financial institute such as a bank may either purchase the registry of profiles 50 from system 10 of the present invention (assuming that it only purchases those profiles 50 that include affiliated data in financial data field 62 from that institution, not the complete listing set of system 10) or it may alternatively, simply link to profiles 50 of system 10. In either event this gives the bank access not only to the account of subscriber 18 but also to the attached information in the financial data field 62 of profile 50 for its customers. For example, if system 10 maintains some number of subscribers 18 who bank at Bank ABC, and those users maintain their financial data in financial data field 62, then Bank ABC will have access to each of the accounts for those subscribers 18. Thus qualifying financial institutions maintain a list of subscribers 18 who have accounts with their bank.

Such an arrangement allows cross-services promotions, encouraging subscribers 18 to open accounts at banks which allow access using their account information. The advantageous functions of such an arrangement are evident because banks typically use passwords or other such identifiers, as well as account numbers in order for a person to access and work with their accounts. Using the present invention, a bank may simply add an additional layer to their voice command structure requesting an ENUM or other unique identification code from the caller.

Thus, at a second step 202, if the caller is a subscriber 18 to system 10 and maintains their financial information (including passwords, and account identifiers) in financial data field 62 with system 10, the subscriber can enter their contact telephone number identifying their ENUM account. In turn, at step 204, the bank then employs the data from ENUM profile 50 to allow subscriber 18 to access their account with the bank. For added security, it is understood that additional security data may be stored in the account such as those provided in field 82, such as biometric or other personal identifying data to be verified when the call to the institution is made.

Such an arrangement reduces the amount of input required by subscriber 18 to access their bank accounts each time they connect to the banking institution, by storing all the necessary security and personal identification information with their ENUM account.

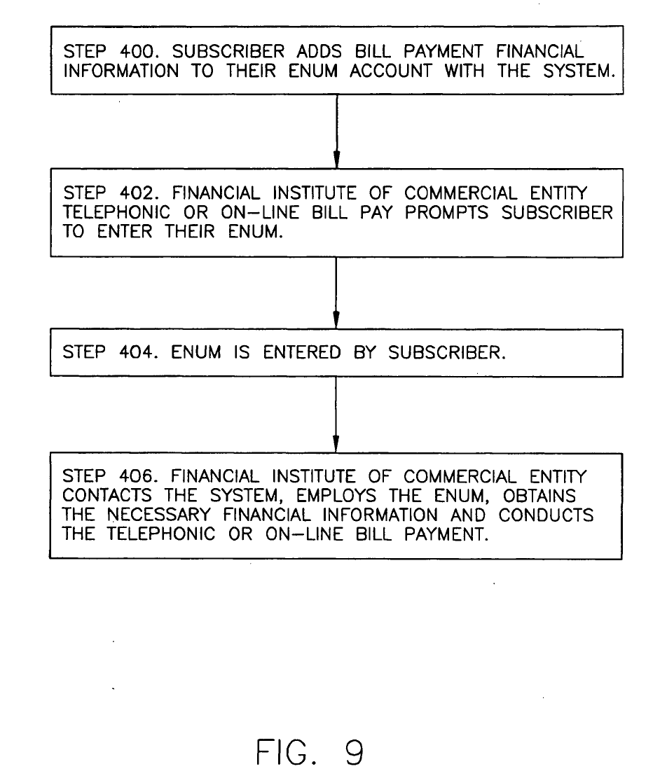

In another embodiment of the present invention, as illustrated in flow chart FIG. 9, using the same ENUM account in system 10 and the related financial data in financial data field 62, a bank or other commercial institution may offer subscriber 18 additional services related to their financial information. For example, in step 300, if subscriber 18 adds a credit card account information as well as their electric bill account number to financial data field 62 of profile 50 for their account.

At step 302, a financial institution or commercial entity offers the ability to pay bills online using the account info from the financial data field 62 of profile 50 by adding an additional layer to their voice command structure requesting an ENUM or detecting their ANI or MIN from the caller. At step 304, subscriber 18 enters their ENUM when prompted and at step 306, the financial or commercial institute, after verifying the security data from the account, accesses financial data field 62 of profile 50 and affects payment of the desired bill.

Such an arrangement allows flexibility when bills are paid electronically as opposed to the more rigid timing of money transfers under current electronic bill payment methods offered directly through the utilities themselves.

Again the Examples of different banking services that can be controlled through the account with system 10 using supplemental services platform 40 are too numerous to recount in detail. It is understood that any similar account which allows storage and use of financial data in addition to traditional ENUM functions are also within the contemplation of the preset invention. Furthermore, for all purchase transactions referred to in connection with FIG. 7, subscriber's financial data can be uses for making payments to the vendors and suppliers.

In another embodiment of the present invention, system 10 further supports directory assistance for callers 20 seeking the ENUM contact telephone of another person. Currently, although ENUM is available to subscribers 18 of system 10 as well as through other services, there is no way for caller 20 to get the ENUM contact number of a subscriber 18 unless it is given to them.

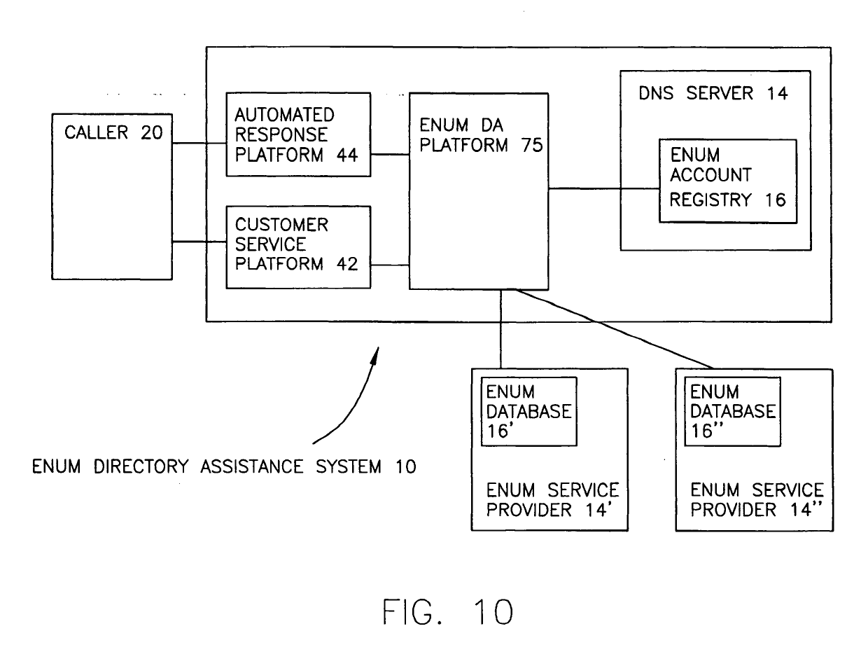

In one embodiment of the present invention as illustrated in FIG. 10, system 10 acts as a Directory Assistance (DA) platform for providing ENUM's to callers 20. Callers 20 contact system 10 through traditional methods, either electronic (text) or telephonic. Electronic communications to system 10 from caller 20 may come in the form of e-mail, HTTP, SMS, IM or any other type of electronic format. Telephonic communications to system 10 may come via VoIP, mobile or traditional land-line telephones. Regardless of format, system 10 contemplates receiving the incoming request at either automated response platform 44 or Customer Service Representative platform 42, if a live operator is required. Both automated platform 44 and live operator platform 42 can handle both electronic and telephonic calls from caller 20.

Queries to system 10 for the ENUM contact number of an individual are handled with help of DA query platform 75 and are searched against both ENUM account registry 16 of DNS server 14 as well as against other ENUM provider 14′ ENUM databases 16′. Thus, for example, if caller 20 is seeking the ENUM contact number of an individual and they happen to have their ENUM account supported by system 10 then that requested ENUM contact telephone number can be retrieved from ENUM account registry 16. However, if requested ENUM contact telephone number is from a user who is not a subscriber to system 10, but instead has their ENUM supported by third party ENUM provider 14′, then DA query platform 75 of system 10 may look up the data directly through connections with ENUM databases 16′ of providers 14′ or any other third party repository of ENUM account data.

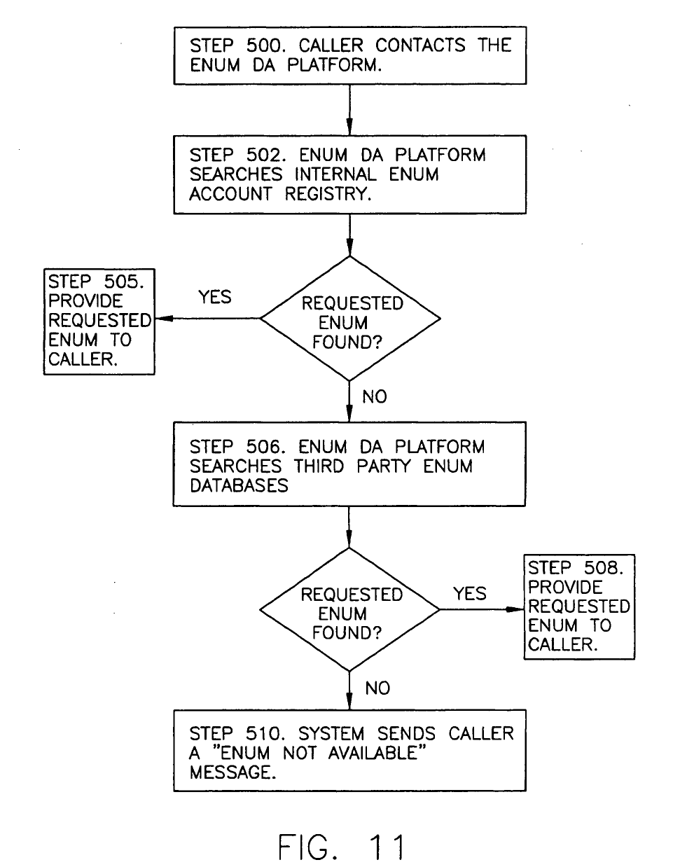

As illustrated in flow chart FIG. 11 in a first step 400, caller 20 contacts ENUM DA platform system 10 and provides a search request to either automated platform 44 or live operator platform 42. Next, at step 402, DA query platform 75 receives search request from automated platform 44 or live operator platform 42 and checks against ENUM account registry 16 to see if the desired ENUM contact telephone number is of a subscriber 18 of system 10. If yes, then at step 404 it is provided to caller 20 as requested. If not, then at step 406 DA query platform 75 checks against other ENUM databases 16′ or any other external repository of ENUM data. If a match is found, at step 408 the requested data is sent to caller 20. If the requested ENUM data is not found then at step 410, system 10 sends caller 20 a response that the requested data is not available. This flow is intended only as an example, an alternative flow may include a search of both ENUM account registry 16 and third party ENUM databases 16′ simultaneously.

It is understood that the above description of DA services for ENUM is for exemplary purposes only. Any additional directory assistance features including enhanced delivery methods, enhanced customer service methods, priority queuing, or any other known directory assistance enhancements used in conjunction with the above described ENUM DA queries are within the contemplation of the present invention.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. An identification services system comprising:
a database module configured to support an account for a subscriber, said account having at least one identification code relating to said subscriber;
a services platform coupled to said database module configured to allow said subscriber of said account to map any one of a plurality of objects, and locations to said account, each of said mapped objects and locations having a unique identifier such that information corresponding to said objects and location is provided for storage in said database module using said account, said identification code and said unique identifiers being communicated to said services platform and being associated to said subscriber account; and
a response platform configured to communicate with said subscriber, said response platform providing updated advertising information to said subscriber based on said information received corresponding to said objects and locations.

2. An identification service system according to claim 1, wherein said unique identifier for objects and locations is embedded in an RFID tag.

3. An identification service system according to claim 2, wherein a subscriber mobile device includes an RFID tag reader so as to provide said identification code relating to said subscriber.

4. The identification service system according to claim 1, wherein said identification code relating to said subscriber is provided via Internet.

5. The identification service system according to claim 1, wherein said unique identifiers corresponding to mapped objects and locations are provided to said services platform via Internet.

6. The identification service system according to claim 1, wherein said unique identifiers of said mapped objects and locations are stored in said services platform in a subscriber profile.

7. The identification service system according to claim 6, wherein said subscriber profile includes an attached devices field for storing information related to electronically connected mapped objects and locations.

8. The identification service system according to claim 6, wherein said subscriber profile includes a unique ID field for storing information to additional mapped physical objects.

9. The identification service system according to claim 6, wherein said subscriber profile includes an authentication field for storing information that stores security information for allowing said subscriber to access said profile.

10. The identification services system according to claim 6, wherein said subscriber profile includes an ordering information field for storing instructions of said subscriber for ordering commercial items via said identification services system.

11. The identification services system according to claim 10, wherein said subscriber profile includes an financial information field for storing financial information of said subscriber for ordering commercial items via said identification services system.

12. The identification service system according to claim 3, wherein said subscriber identification code is provided via said subscriber mobile device.

14. The identification service system according to claim 12, wherein said subscriber identification code is said subscriber's MIN and or ANI.

15. The identification service system according to claim 1, wherein said services platform communicates with a plurality of goods and service providers, so as to provide messages to all subscribers that the system indicates have possession of products similar to said providers' products or employ services similar to said providers' services.

16. The identification service system according to claim 15, wherein said messages include advertising and promotional messages.

17. The identification service system according to claim 15, wherein said messages include product alerts.

18. The identification service system according to claim 15, wherein said messages include product expiry notifications.

19. The identification service system according to claim 15, wherein said messages include medicine dosage and reminder messages.

20. An identification services system comprising:
a database module configured to support an account for a subscriber, said account having at least one identification code relating to said subscriber;
a services platform coupled to said database module configured to allow said subscriber of said account to map any one of a plurality of objects, and locations to said account, each of said mapped objects and locations having a unique identifier such that information corresponding to said objects and location is provided for storage in said database module using said account, said identification code and said unique identifiers being communicated to said services platform and being associated to said subscriber account; and
a response platform configured to communicate with said subscriber, said response platform providing updated shopping list corresponding to objects that are desired by said subscriber to be replenished.

21. An identification service system according to claim 13, wherein said unique identifier for objects and locations is embedded in an RFID tag.

22. An identification service system according to claim 14, wherein a subscriber mobile device includes an RFID tag reader so as to provide said identification code relating to said subscriber.

23. The identification service system according to claim 13, wherein said identification code relating to said subscriber is provided via Internet.

24. The identification service system according to claim 13, wherein said unique identifiers corresponding to mapped objects and locations are provided to said services platform via Internet.

25. The identification service system according to claim 20, wherein said unique identifiers of said mapped objects and locations are stored in said services platform in a subscriber profile.

26. The identification service system according to claim 25, wherein said subscriber profile includes an attached devices field for storing information related to electronically connected mapped objects and locations.

27. The identification service system according to claim 25, wherein said subscriber profile includes a unique ID field for storing information to additional mapped physical objects.

28. The identification service system according to claim 25, wherein said subscriber profile includes an authentication field for storing information that stores security information for allowing said subscriber to access said profile.

29. The identification services system according to claim 25, wherein said subscriber profile includes an ordering information field for storing instructions of said subscriber for ordering commercial items via said identification services system.

30. The identification services system according to claim 29, wherein said subscriber profile includes an financial information field for storing financial information of said subscriber for ordering commercial items via said identification services system.

31. The identification service system according to claim 23, wherein said subscriber identification code is provided via said subscriber mobile device.

32. The identification service system according to claim 31, wherein said subscriber identification code is said subscriber's MIN, ANI or ENUM.

33. The identification service system according to claim 20, wherein said services platform communicates with a plurality of goods and service providers, so as to provide information relating to subscribers that have possession of products similar to said providers' products or employ services similar to said providers' services.

34. The identification service system in accordance with claim 33 further comprising a shopping list aggregator that compiles a list of said mapped objects that are desired to be replenished when said objects are missing or when said objects are expired.

35. The identification service system in accordance with claim 33 further comprising a list of preferred vendors wherein said missing or expired objects can be purchased.

36. The identification service system in accordance with claim 35, wherein orders for said items to be replenished is automatically sent by said services platform.

37. The identification system in accordance with claim 33, wherein a list of vendors is compiled to replenish missing goods, based on a least cost algorithm to find the best deals for all subscribers that are desirous of specific goods or objects.

38. The identification system in accordance with claim 34, wherein comparative pricings from various participating vendors are complied based on the desired items contained in said shopping lists.

39. An identification services system comprising:
a database module configured to support an account for a plurality of subscribers, said account having at least one identification code relating to each of said subscribers;
a services platform coupled to said database module configured to allow said subscribers of said account to map any one of a plurality of objects, and locations to said account, each of said mapped objects and locations having a unique identifier such that information corresponding to said objects and location is provided for storage in said database module using said account, said identification code and said unique identifiers being communicated to said services platform and being associated to said subscriber account; and
a response platform configured to communicate with said subscriber, said response platform configured to receive information identifying a lost object via a mobile device and based on said information enabling said system to retrieve the identity of the owner of said object.

40. An identification service system according to claim 39, wherein said unique identifier for objects and locations is embedded in an RFID tag.

41. An identification service system according to claim 40, wherein a subscriber mobile device includes an RFID tag reader so as to provide said identification code relating to said subscriber.

42. The identification service system according to claim 39, wherein said identification code relating to said subscriber is provided via Internet.

43. The identification service system according to claim 39, wherein said unique identifiers corresponding to mapped objects and locations are provided to said services platform via Internet.

44. The identification service system according to claim 41, wherein said subscriber identification code is provided via said subscriber mobile device.

45. The identification service system according to claim 44, wherein said subscriber identification code is said subscriber's MIN and or ANI.
